(19) United States
(12) Patent Application Publication
(10) Pub. No.: US 2016/0275626 A1
(43) Pub. Date: Sep. 22, 2016

(54) METHOD AND APPARATUS FOR ACCOUNTING PROCESS USING INTEGRATED TRIAL BALANCE

(71) Applicant: Deok Ku Lee, Seoul (KR)

(72) Inventor: Deok Ku Lee, Seoul (KR)

(21) Appl. No.: 15/074,072

(22) Filed: Mar. 18, 2016

(30) Foreign Application Priority Data
Mar. 18, 2015 (KR) 10-2015-0037290
Mar. 10, 2016 (KR) 10-2016-0029081

(51) Int. Cl. G06Q 40/00

(52) U.S. Cl. CPC G06Q 40/12

(57) ABSTRACT

Provided is a method for an accounting process using an integrated trial balance executed by a processor, including: presenting the integrated trial balance, the integrated trial balance including a first column and a second column, the first column displaying information on an asset, the second column displaying information on a liability and a capital, the information on the asset, the liability, and the capital share including accounts corresponding to each element, and the capital share and values associated with each account title, receiving an account select signal selecting one of the accounts displayed in the integrated trial balance and presenting transaction types for the selected account titles based on a predetermined accounting rule table, the accounting rule table including possible transaction types according to the accounts and information on fixed recording contents according to a combination of the accounts and the transaction types, receiving a transaction type select signal selecting one of the presented transaction types, and presenting a transaction information input screen generated depending on the accounting rule table based on the selected account titles and transaction type, the transaction information input screen including a debit side and a credit side and the fixed recording contents determined depending on the accounting rule table being input to at least one of the debit side and the credit side in advance and being displayed.

### CROSS-REFERENCE TO RELATED APPLICATION(S)

This application claims priority to Korean Patent Application No(s). 10-2015-0037290 and 10-2016-0029081, filed on Mar. 18, 2015, and Mar. 10, 2016, respectively, the disclosures of which are incorporated herein by reference in their entirety.

### BACKGROUND OF THE INVENTION

1. Field of the Invention

The present disclosure relates to a method and an apparatus for an accounting process, and more particularly, to a method and an apparatus for an accounting process using an integrated trial balance.

2. Description of the Related Art

Modern accounting established by Luca Pacioli in the 15th century has played a considerable role in company development. In recent years, with the development of a computer, computerized accounting apparatuses are more getting popular. However, despite of the development of a computer, the existing accounting programs simply imitate pages of a traditional accounting ledger and display them on a computer screen. That is, the existing accounting programs merely input contents that used to be recorded on paper through a computer, and therefore users are in almost full charge of inputting data like transactional information. Therefore, even though users use the existing accounting programs, books recorded by the users with no professional accounting knowledge have many errors which do not conform to accounting rules. Therefore, even though the users use the existing accounting programs, it is extremely difficult to do accounting business without an exclusive knowledge of accounting.

### SUMMARY OF THE INVENTION

The present disclosure relates to a method and an apparatus for an accounting process using an integrated trial balance.

A method for an accounting process using an integrated trial balance executed by a processor, comprises: presenting the integrated trial balance, the integrated trial balance including a first column and a second column, the first column displaying information on an asset, the second column displaying information on a liability and a capital, the information on the asset, the liability, and the capital including account titles belonging to the asset, the liability, and the capital and values associated with each account title, the integrated trial balance having a recording mode and a settlement mode, if at least some of the account titles on the integrated trial balance are selected in the recording mode, a transaction information input process of the corresponding account title starting, and if at least some of the account titles on the integrated trial balance are selected in the settlement mode, a settlement adjustment process of the corresponding account title starting; receiving a first select signal selecting one of the account titles displayed in the integrated trial balance in the recording mode; presenting transaction types for the selected account titles based on a predetermined account attribute table, the account attribute table including possible transaction types according to the account titles and information on automatic recording contents according to a combination of the account titles and the transaction types; receiving a second select signal selecting one of the presented transaction types; and presenting a transaction information input screen generated depending on the account attribute table based on the selected account titles and transaction type, the transaction information input screen including a debit side and a credit side and the automatic recording contents determined depending on the account attribute table being automatically input to at least one of the debit side and the credit side and being displayed.

The account titles and an increased amount, a decreased amount, and a balance for the account titles are displayed in both of the first column and the second column of the integrated trial table.

The debit side and the credit side of the transaction information input screen each includes an amount input blank for each account title, and the method further comprises: confirming whether a total of amounts input to all amount input blank of the debit side is equal to a total of amounts input to all amount input blank of the credit side; and generating an alarm when the total of the amounts input to all amount input blank of the debit side is not equal to the total of the amounts input to all amount input blank of the credit side.

The debit side and the credit side of the transaction information input screen each include an amount input blank for each account title, the method further comprises: confirming whether a total of the amounts input to all amount input blank of the debit side is equal to a total of the amounts input to all amount input blank of the credit side; and when a total of amounts of the debit side is equal to a total of amounts of the credit side, updating amount input of each account title to the value of the corresponding account title in the integrated trial balance.

The method further comprises: prior to the presenting of the integrated trial balance, receiving a business select signal for a business field; and configuring the integrated trial balance with account titles to be used in the selected business field depending on a predetermined business attribute table, based on the business select signal.

The method further comprises: after the presenting of the transaction information input screen, receiving a settlement mode signal; generating an identification mark for the account titles requiring the settlement adjustment among the account titles in the integrated trial balance; and displaying matters to be input by a user for the corresponding account title depending on a predetermined settlement adjustment table if one of the account titles for which the identification mark is generated is selected.

A computer-readable recording medium comprising computer executable instructions, which, when executed by a processor, cause the processor to perform the steps of the above method.

An apparatus for an accounting process using an integrated trial balance, comprises: a memory storing an account attribute table including possible transaction types according to account titles and information on automatic recording contents according to a combination of the accounts and the transaction types; and a processor connected to the memory, wherein the processor performs an operation of presenting the integrated trial balance to a user device, the integrated trial balance including a first column and a second column, the first column displaying information on an asset, the second column displaying information on a liability and a capital, the information on the asset, the liability, and the capital including account titles belonging to the asset, the liability, and the capital and values associated with each account title, the integrated trial balance having a recording mode and a settlement mode, if at least some of the account titles on the integrated trial balance are selected in the recording mode, a transaction information input process of the corresponding account title starting, and if at least some of the account titles on the integrated trial balance are selected in the settlement mode, a settlement adjustment process of the corresponding account title starting, and the processor performs an operation of receiving a select signal selecting one of the account titles and one of the transaction types of the corresponding account title displayed in the integrated trial table in the recording mode and presenting a transaction information input screen generated according to the account attribute table based on the selected account titles and transaction types, the transaction information input screen including a debit side and a credit side and the automatic recording contents determined depending on the account attribute table being automatically input to at least one of the debit side and the credit side and being displayed.

An apparatus for an accounting process using an integrated trial balance, comprises: an account title database per business field defining account titles to be displayed in the integrated trial balance per business field; an account attribute database defining attributes of each account, the account attribute database storing display information when the account titles are selected in a recording mode or a settlement mode; an integrated trial balance configuration module configuring the integrated trial balance including the account titles based on the account title database per business field according to the business field selected by a user, the integrated trial balance including a first column and a second column, the first column displaying information on an asset, the second column displaying information on a liability and a capital, the information on the asset, the liability, and the capital including account titles belonging to the asset, the liability, and the capital and values associated with each account title, the integrated trial balance having a recording mode and a settlement mode, if at least some of the account titles on the integrated trial balance are selected in the recording mode, a transaction information input process of the corresponding account title starting, and if at least some of the account titles on the integrated trial balance are selected in the settlement mode, a settlement adjustment process of the corresponding account title starting; a transaction information input module presenting transaction types for the selected account titles based on the account attribute database when a first select signal selecting one of the account titles displayed in the integrated trial balance is received in the recording mode and presenting a transaction information input screen generated depending on the account attribute database based on the selected account title and transaction type; and a settlement management module generating an identification mark for the account titles requiring the settlement adjustment among the account titles of the integrated trial balance in the settlement mode and displaying matters to be input by the user for the corresponding account title based on the account attribute database if one of the account titles for which the identification mark is generated is selected.

### BRIEF DESCRIPTION OF THE DRAWINGS

FIG. 1 is a diagram illustrating a general accounting process of the existing accounting program.

FIG. 2 is a diagram illustrating a general statement input screen of the existing accounting program.

FIG. 3 is a diagram illustrating a total trial balance of the existing accounting program.

FIG. 4 is a diagram illustrating an accounting process of an accounting program according to an exemplary embodiment of the present disclosure.

FIG. 5 is a diagram illustrating an integrated trial balance screen of an accounting program according to an exemplary embodiment of the present disclosure.

FIG. 6 is a block diagram of an apparatus for an accounting program according to an exemplary embodiment of the present disclosure.

FIG. 7 is a diagram illustrating screens of cases in which acquisition or disposal of short-term financial instruments is selected in the accounting program according to an exemplary embodiment of the present disclosure.

FIG. 8 is a diagram illustrating screens depending on a settlement adjustment type when the settlement of the short-term financial instruments is adjusted in the accounting program according to an exemplary embodiment of the present disclosure.

FIG. 9 is a diagram illustrating screens of cases in which acquisition or disposal of machinery and fixed equipment is selected in the accounting program according to an exemplary embodiment of the present disclosure.

FIG. 10 is a diagram illustrating screens of cases in which a purchase of raw materials is selected in the accounting program according to an exemplary embodiment of the present disclosure.

FIG. 11 is a diagram for describing screens of detailed information that may be derived from an integrated trial balance of the accounting program according to an exemplary embodiment of the present disclosure.

FIG. 12 is a diagram for describing screens that may be displayed upon a settlement mode in the integrated trial balance of the accounting program according to an exemplary embodiment of the present disclosure.

### DESCRIPTION OF SPECIFIC EMBODIMENTS

Hereinafter, exemplary embodiments of the present disclosure will be described in detail with reference to the accompanying drawings.

Although the following text sets forth a detailed description of numerous different embodiments, it should be understood that the legal scope of the description is defined by the words of the claims set forth at the end of this application. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. It should also be understood that, unless a term is expressly defined in this application, there is no intent to limit the meaning of that term, either expressly or by implication, beyond its plain or ordinary meaning.

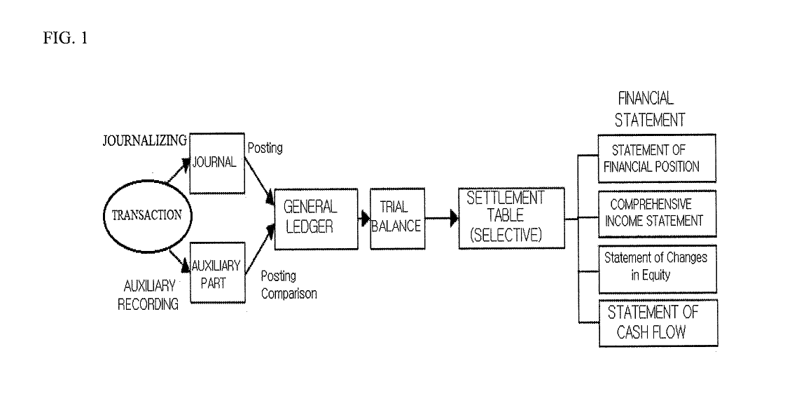

FIG. 1 is a diagram illustrating a general accounting process of the existing accounting program.

A general accounting process will be briefly described as follows. i) Accrual of transaction, ii) Journalizing of transaction and record of journal, iii) Posting to general ledger, and iv) Term-end account (book closing and preparation of financial statements).

When transactions occur, the transactions are recorded in a journal in order. Considerable accounting knowledge is required to determine which account title should be used, which account has corresponding relation and which account goes to which side of the debt side and the credit side for the transaction.

For example, it is assumed that Mr. A invests 1,000,000 won on Feb. 1 to open Alpha company and purchases equipment of 500,000 on Feb. 2 on credit. The journal needs to be recorded as follows.

TABLE 1
Journal

| | | Ledger | Debit | Credit |
|---|---|---|---|---|
| Date | Description | No. | Side | Side |
| February 1 | Cash | 1 | 1,000,000 | |
| | Capital Share | 40 | | 1,000,000 |
| | Invest cash to | | | |
| | open company | | | |
| February 2 | Equipment | 15 | 500,000 | |
| | Others payable | 26 | | 500,000 |
| | Purchase equipment | | | |
| | on credit | | | |
| February 3 | Rent | 62 | 400,000 | |
| | Cash | 1 | | 400,000 |
| | Pay rent | | | |

Generally, the journalizing of the journal needs to be post as the general ledger. The ledger posting may set the effect of journalized transactions in an individual account. The journalizing of the above Table 1 is posted to the general ledger depending on the respective accounts as follows.

TABLE 2
General Ledger

| | | | | | | | |
|---|---|---|---|---|---|---|---|
| | | Ledger | | | | Ledger | |
| Date | Description | No. | Amount | Date | Description | No. | Amount |

Cash
No. 1

| | | | | | | | |
|---|---|---|---|---|---|---|---|
| Feb. 1 | Capital | 1 | 1,000,000 | Feb. 3 | Rent | 1 | 400,000 |

Equipment
No. 15

| | | | |
|---|---|---|---|
| Feb. 2 | Others | 1 | 500,000 |
| | payable | | |

Others payable
No. 26

| | | | |
|---|---|---|---|
| Feb. 2 | Equipment | 1 | 500,000 |

Capital
No. 40

| | | | |
|---|---|---|---|
| Feb. 1 | Cash | 1 | 1,000,000 |

Rent
No. 62

| | | | |
|---|---|---|---|
| Feb. 3 | Cash | 1 | 400,000 |

The above record is continued during the accounting period and the term-end account is performed at the end of the accounting period. The settlement (term-end account) closes various kinds of ledgers recorded during the period and prepares financial statements. During the settlement procedure, a trial balance is prepared.

The trial balance (T/B) is an account balance list at a specific time. The trial balance is to inspect whether the debit side conforms to the credit side after the posting. In sophisticated business accounting, errors may occur in the journalizing record or the ledger posting, and therefore the trial balance needs to be prepared. The trial balance prepared for the settlement may be diverse, but a total trial balance will be described as an example herein. For example, the total trial balance depending on the above Tables 1 and 2 is shown as follows.

TABLE 3
Total Trial Balance
Feb. 29, 2016

| Debit Side | | Ledger | | Credit Side | |
|---|---|---|---|---|---|
| Balance | Total | No. | Account Title | Balance | Total |
| 600,000 | 1,000,000 | 1 | Cash | | 400,000 |
| 500,000 | 500,000 | 15 | Equipment | | |
| | | 26 | Others payable | 500,000 | |
| | | 40 | Capital Share | 1,000,000 | |
| 400,000 | 400,000 | 62 | Rent | | |
| 1,500,000 | 1,900,000 | | | 1,500,000 | 1,900,000 |

If the total amount of the debit side and the total amount of the credit side in the trial balance do not conform to each other, an accounting process performer investigates in which record and calculation errors are present When errors are not present in the trial balance, a statement of financial position and a comprehensive income statement may be prepared based on the trial balance.

The foregoing accounting process is performed even before the computerization and the existing computerized accounting program has been created by imitating the order of the foregoing accounting process.

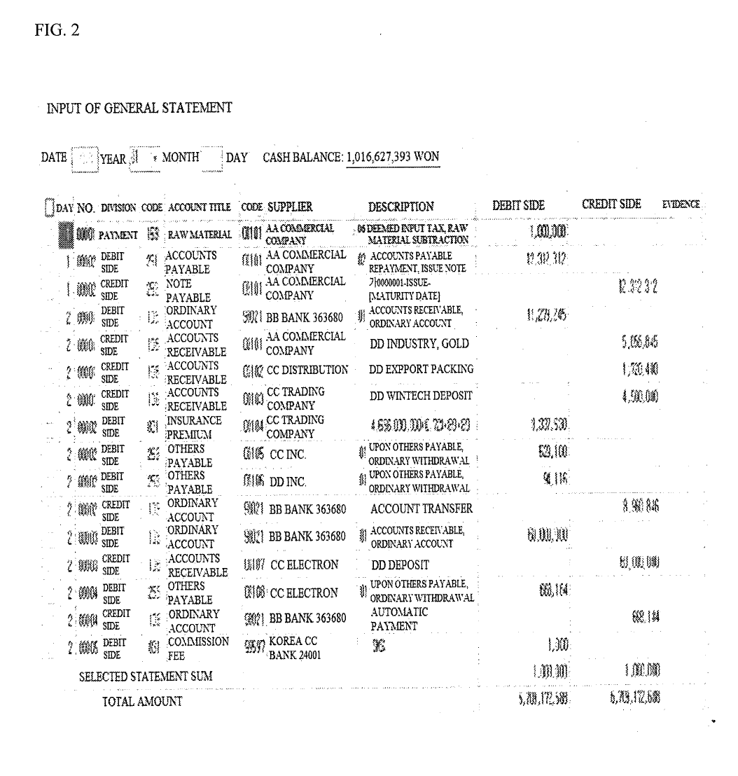

FIG. 2 is a diagram illustrating a general statement input screen of the existing accounting program.

The existing accounting program presents a general statement input screen shown in FIG. 2 or a purchase and sales statement input screen to a user after a log-in of a company registration and a user account. The existing accounting program is to allow a user to input transaction contents to a book in a row depending on the typical accounting process. In the screen configuration, transactions are only arranged long and financial information of an enterprise at a time is not displayed on a computer screen. By the screen configuration as illustrated in FIG. 2, it is very difficult to obtain knowledge about financial situations such as asset, liability, capital, a revenue, and cost that are accounting elements of an enterprise.

Further, a user needs to know variety of account titles which may be recorded and codes therefor and needs to understand which account title has which corresponding relation to other accounts and which account goes to which of the debit side or the credit side for the transaction. Therefore, when the accounting knowledge and ability of the user are insufficient, the recording may not be made properly according to rules of the double-entry bookkeeping system. That is, the typical accounting program does not guarantee the recording conforming to the rules of the double-entry bookkeeping system and does not reasonably guide the user in that manner.

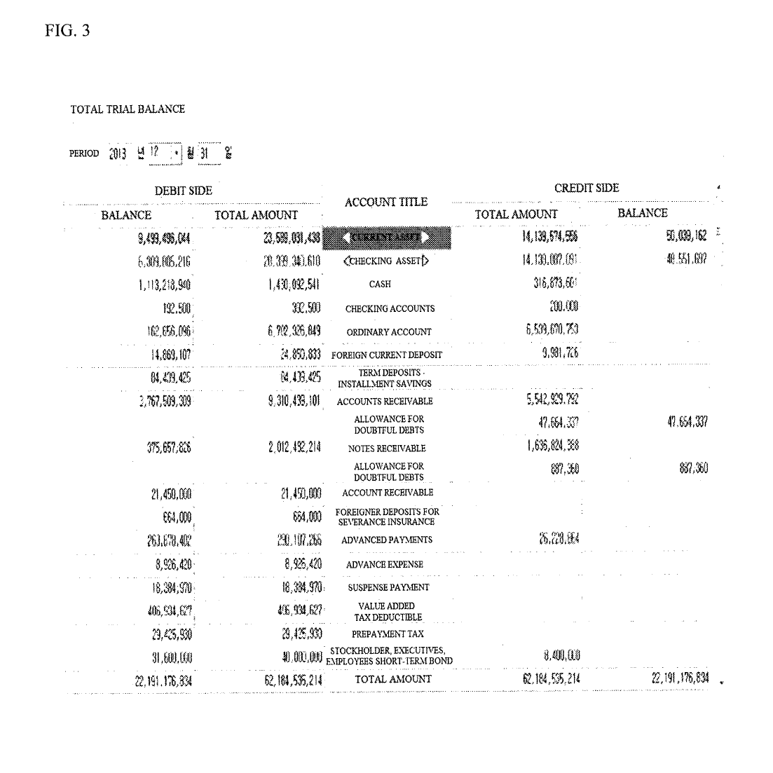

FIG. 3 is a diagram illustrating a total trial balance of the existing accounting program.

Based on the input general statement information and purchase and sales statement information, a total trial balance may be displayed on the screen as illustrated in FIG. 3. The screen configuration follows the typical method for an accounting process before being computerized and is to simply move ones on paper to the computer screen.

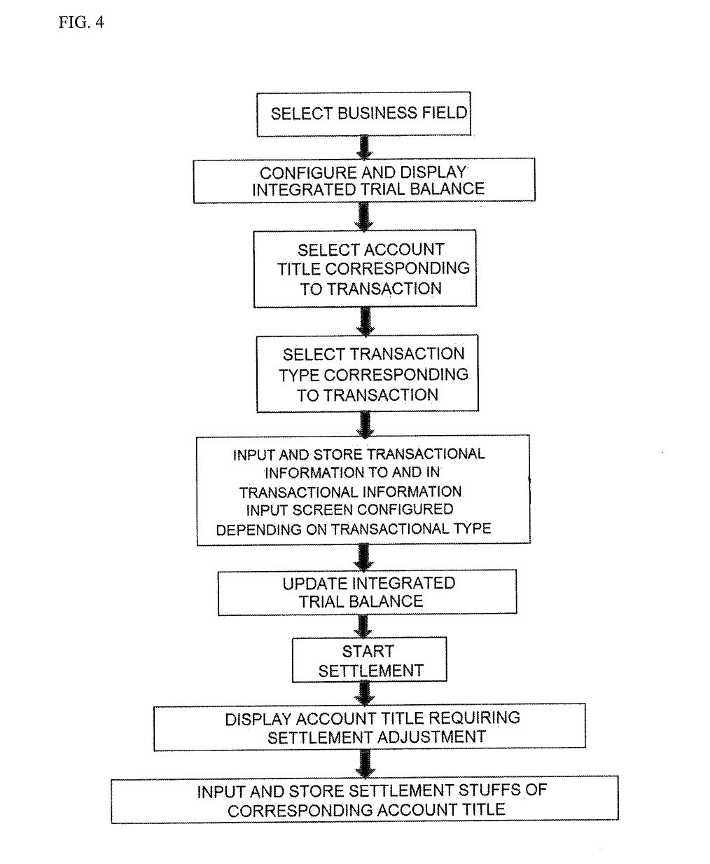

FIG. 4 is a diagram illustrating an accounting process of an accounting program according to an exemplary embodiment of the present disclosure.

According to the present disclosure, if the accounting program is executed, the user account may be generated and the company information may be input. As the company information, information on a company name, a representative name, a corporation or not, industries (service business, manufacturing business, distribution business, etc.), an export or not, a business center/branch, a fiscal year, a corporate/corporation registration number, etc. may be input. When industries or business fields (for example, service business, distribution business, or manufacturing business) are selected, the integrated trial balance including the account titles generally used in each business field is generated and presented depending on the selected business field. Before the integrated trial balance is generated, a list of the account titles belonging to asset, liability, capital, revenue, cost, and manufacturing cost may be presented along with identification (whether to be displayed in the integrated trial balance) proposed by the program and may also be formed to be selected, released, and adjusted by the user. The adjustment may be made by a set up or a change during the accounting period. The account titles to be displayed in the integrated trial balance according to the business field are previously defined and stored in the database of the accounting program according to the present disclosure. For example, when the manufacturing business is selected, the integrated trial balance additionally including the information on account titles such as a raw material, raw material cost, and other manufacturing cost and values associated with the account titles is configured to be presented on the screen. The user may more easily understand financial information of an enterprise using the integrated trial balance that integrally displays the financial information on one screen. Meanwhile, if necessary, the user may be separately allocated with authority to add account titles other than a predefined account title or delete account tiles that are not used.

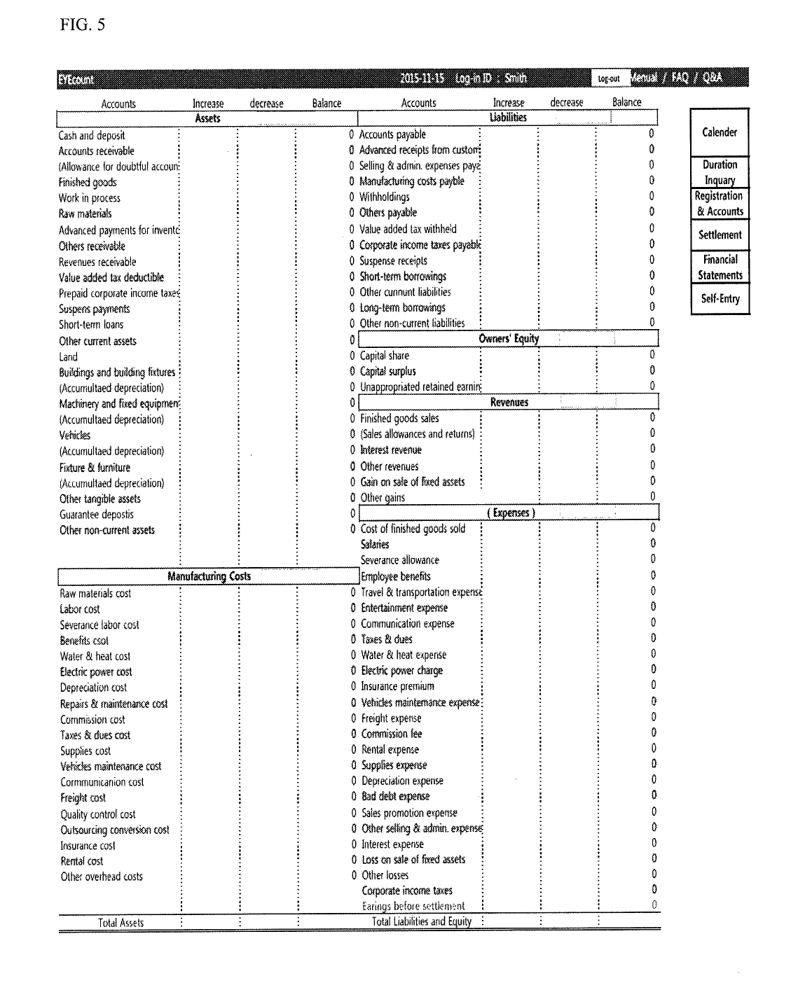

Here, the “integrated trial balance” means a table uniquely devised in the present disclosure that allows an input of transaction information while showing the financial information of the enterprise. FIG. 5 is a diagram illustrating an integrated trial balance screen of an accounting program according to an exemplary embodiment of the present disclosure. The integrated trial balance includes at least a first column and a second column. The information on assets may be displayed in the first column and the information on liabilities and capitals may be displayed in the second column. The information on the assets, liabilities, and capitals includes the account titles corresponding to each element (assets, liabilities, capitals) and values associated with each account title. The values associated with the account titles may include an increase value, a decrease value, and/or a balance for a specific period of the corresponding account titles. A sum of the values associated with the account titles of the first column and a sum of the values associated with the account titles of the second column need to be equal to each other and if they do not conform to each other, an alarm may occur. When a business field is selected as the manufacturing business, the account titles associated with the assets and the manufacturing cost may be displayed in the first column. The account titles associated with the manufacturing costs may include raw material cost, labor cost, severance labor cost, employee benefits cost, etc. The account titles associated with the liability, the capital, the cost, and the revenue may be displayed in the second column. In this case, the values associated with the liability, the capital, and the revenue are summed with each other in the second column and the values associated with costs need to be subtracted and thus the sums in the first column and the second column will conform to each other.

The integrated trial balance may have two modes of a recording mode to which the generated transactions are input and a settlement mode for a term-end account. What the integrated trial balance has the two modes means that the operation performed when a specific item is selected in the integrated trial balance may be different in the first mode and the second mode. If the account titles on the integrated trial balance are selected in the recording mode, a transaction information input process of the corresponding account title may start and if the account titles on the integrated trial balance are selected in the settlement mode, a settlement adjustment process of the corresponding account title may start. A conversion into the settlement mode of the integrated trial balance may be made by selecting a settlement menu or clicking a settlement button. A benefit before the settlement or a loss before the settlement may be displayed in the integrated trial balance for the accounting period.

For each account title displayed in the integrated trial balance, attributes of each account title are defined in an account attribute table (or account attribute database). For example, the account attribute table may include possible transaction types (in the case of cash and deposits, cash withdrawal, cash deposit, account transfer, and cash short and over), contents and number of the account titles to be displayed in the debit side and the credit side in each transaction type, contents and number (contents and number of items to be additionally input) of attributes included in each account title in the debit side and the credit side, to which of the credit side or the debit side the account titles of each transaction type belong, account type (general, a partial self-input, special self-input, and book input) Further, i) the attributes and the relevant book depending on the transaction type for the accounting period (recording period) and/or ii) the attribute and the relevant book upon the term-end account (settlement period) may be defined in the account attribute table. That is, the account attribute table may define the information to be used/requested upon the transaction input for the accounting period and the information to be used/requested in the settlement adjustment upon the settlement, depending on the combination of account title and transaction type. The attribute definition may be stored in the database of the accounting program in various types and may be updated.

There may be defined in the account attribute table that for example, in the case of the raw material, i) as the attributes depending on the transaction type for a recording period, the raw material and value added tax deductible may be displayed in the debit side upon the purchase, accounts payable may be displayed in the credit side, a space for item may be displayed in the raw material of the debit side, and customers and suppliers need to be additionally input/selected in the accounts payable of the credit side. upon allowance on purchases, the accounts payable may be displayed in the debit side, and the raw material and the value added tax deductible may be displayed in the credit side, spaces for customers and suppliers may be displayed in the accounts payable of the debit side, and a space for item may be additionally filled/selected in the raw material of the credit side. A raw material purchase book and raw material receipts and payments may be defined in the relevant book of the raw material. For the items to be previously input and displayed in the transaction detailed information, displaying the account titles of the debit side upon the purchase of the raw material and the accounts payable in the account title of the credit side may be additionally defined in the account attribute table.

For another example, there may be defined in the account attribute table that in the case of the case and deposits, there are four transaction types of 1) cash withdrawal, 2) cash deposit, 3) account transfer, 4) cash short and over, in the case of the cash short and over, two account titles (cash and deposits and other losses) may be displayed in the debit side, two account titles (cash and deposits and other gains) may be displayed in the credit side. Each account title further includes an attribute called details in addition to the account title and the amount, the cash and deposits of the cash short and over are displayed in the debit side and the corresponding account type is general.

If a transaction occurs, the user selects the account title associated with the corresponding transaction in the integrated trial balance. For the selected account tile, the transaction type that may be possible in the corresponding account title is presented. If one of the possible transaction types is selected, the transaction information input screen is displayed on a window or a screen depending on the selected transaction type. The debit side and the credit side are displayed on the transaction information input screen depending on the attribute of the selected transaction type and at least account title and an amount blank are generated in each of the debit side and the credit side. According to another exemplary embodiment, the account transaction types depending on the account title are displayed in the integrated trial balance and thus the user may also immediately select one of the transaction types depending on the account title.

For example, if the “raw material” account is selected by the user purchasing the raw material, the possible transaction types (purchase, allowance on purchases, or purchase return) of the raw material are presented. If the user selects the purchase, the transaction information input screen is displayed on a new window or screen. In the transaction information input screen, depending on the attribute of the raw material purchase of the predetermined account attribute table, the account titles, the items, and the amount blank are formed in the debit side and the account titles, the customers and suppliers, and the amount blank are formed in the credit side. The raw material and the value added tax deductible are displayed in the account title of the debit side depending on the predetermined accounting rules and the items and amount of the debit side may be displayed in the blank for the user input. The accounts payable is displayed in the account title of the credit side and the customers and suppliers and the amount of the credit side appears in a blank for the user input. The ‘description’ may be presented so that the additional matters associated with the transaction may be described in the transaction information input screen. That is, when the purchase of the raw material is selected, the following transaction information input screen may be displayed.

The item and the supplier are presented in the above Table 4, but the title of the small categories like “Item” and “Supplier” may be omitted and the item and the supplier may also be selected among the list of suggestions based on the previous recording of the user. Upon the recording of the transaction, if the user selects one of the account title and the proposed transaction types corresponding to the transaction in the integrated trial balance provided by the accounting program in the present disclosure, as shown in the above Table 4, the transaction information input screen on which the matters to be input to the debit side and the credit side are at least partially automatically displayed. The at least partial automatic bookkeeping may be made since in the accounting rule stored in the account attribute table, categories to be input to each of the debit side and the credit side and contents to be input to the corresponding category are determined in advance depending on the transaction type of the selected account title. Therefore, the user is guided to perform bookkeeping conforming to the accounting rule without high-level accounting acknowledge.

If the user completes the input for the rest portions to be input on the transaction information input screen, the completion or storage button (or simple input of an enter key) may be selected. When the completion or storage button is clicked, the accounting program in the present disclosure determines whether the total amount of the debit side and the total amount of the credit side conform to each other, or otherwise the completion and the storage may be rejected and the alarm may be generated. Based on the alarm, the user is guided to perform the accurate recording. The amount comparison and the alarm may also be performed at the moment that a cursor gets out of the corresponding area before the completion or storage button is pressed and after the amount input to the amount blanks of the debit side and the credit side is completed. Alternatively, if all of the minimally required amount blanks of the debit side and the credit side are filled, the rest amount blanks may be automatically input by the accounting program so that the total of the debit side and the total of the credit side conform to each other.

If all the transaction information is accurately input and the storage or completion button is clicked, the integrated trial balance is updated based on the input contents. For example, if 1,000,000 Korean won is input as the purchase of the raw material, the increase (debit side) and the balance of the raw material account title are increased by 1,000,000 won. If the transaction information is input and managed by the foregoing method, the user may always understand the financial state of the enterprise at that time without generating a separate report.

If the settlement is required at the end of the accounting period, the user may click a menu for performing the settlement at the interface of the accounting program. If the settlement menu is selected, a specific mark (for example, shadow mark) may be made in the account titles in which the settlement matters to be necessarily performed are present. If the user clicks the shaded account title, all the processing matters required upon the settlement and the settlement adjustment screen showing the journalizing are displayed. The user may input and store depending on the settlement adjustment screen and then the settlement adjustment for the settlement matters may be performed. The accounting program in the present disclosure may display the order of the settlement adjustment as well as displaying the account title which is to be adjusted upon the settlement. The function may display which of the account titles needs to be first subjected to the settlement adjustment on the integrated trial balance, or when the account title of which settlement needs to be adjusted later is selected, an alarm for the account title that needs to be first adjusted may be generated.

For example, upon the settlement of the cash and deposits, the short-term financial instruments, etc., a gain on interest needs to be calculated and upon the settlement of accumulated depreciation of a building, machinery and fixed equipments, vehicles, fixture and furniture, etc., a depreciation is required. Therefore, if the cash and deposits account in which the settlement matters are present is clicked, the following settlement adjustment screen is displayed.

The accounting program of the present disclosure displays the account titles requiring the settlement matters when the settlement mode is performed and the settlement adjustment screen is provided as shown in the above Table 5, thereby guiding the user to progress the settlement adjustment in an appropriate order without omission. Therefore, the accounting program of the present disclosure may prevent any confusion, an omission, and an error that are experienced in most companies upon the settlement.

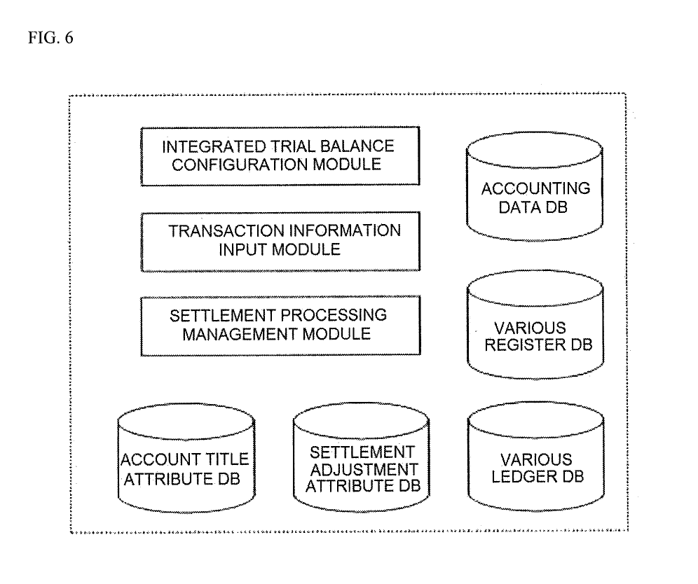

FIG. 6 is a block diagram of an apparatus for an accounting program according to an exemplary embodiment of the present disclosure.

An apparatus for an accounting process may include an integrated trial balance configuration module, a transaction information input module, a settlement management module, an accounting data database (DB), an account title per business field database (DB), various registration database (DBs), various book database (DBs), various receipts and payments database (DBs), and an account attribute database (DB). Further, the apparatus for an accounting process may further include a settlement attribute database (DB) that defines attributes per account title upon the settlement mode. However, the attributes per account title upon the settlement mode may also be integrated as the account attribute database. Meanwhile, the configuration module, the input module, and the management module may be integrated by one or more control means and may also be represented. Further, each database may be locally stored in a computer executing the accounting program or may also be stored in a remote server that may communicate with the computer.

The integrated trial balance configuration module may configure the integrated trial balance that is displayed on a monitor depending on the selection of the business field. The configuration may be made based on the account title DB per business field storing the account titles per business field which will be displayed in the integrated trial balance. The transaction information input module may serve to configure the transaction information input screen depending on the account title and the transaction type on the integrated trial balance selected by the user and process the input transaction information. When the settlement menu is selected, the settlement management module may serve to display the account title requiring the settlement adjustment or display the matters to be input upon the settlement adjustment of the corresponding account title. Each module may be functioned by referring to the database in which the information for performing the function is stored.

Transaction information data that are input by the user may be stored in the accounting data DB. Various registration DB may store information on various registrations such as a company registration, an employee registration, a credit card registration, a customers and suppliers registration, a tangible assets registration, a land registration, an investment center registration, a suppliers registration, a machinery and fixed equipments registration, a fixture and furniture registration, and a buildings and building fixtures registration. The company registration may store information on a company name, a representative name, a corporation or not, industries (service business, manufacturing business, distribution business, etc.), an export or not, an investment center/branch, a fiscal year, a corporate/corporation registration number, etc. The information may be acquired from the user when the accounting program is performed first and may be collected. Various book DBs may store information on various books such as a depreciation book, a raw materials purchase book, a production book, a sales book, and a service export book. The receipts and payments database may store information on the raw material receipts and payments, finished goods receipts and payments, and merchandise receipts and payments. The settlement attribute DB may store information on the account title to be adjusted upon the settlement and matters to be input upon the settlement adjustment of the corresponding account title. The account attribute DB may store information on the category to be input upon the transaction input of each transaction title and matters to be automatically displayed by being input to the debit side and the credit side.

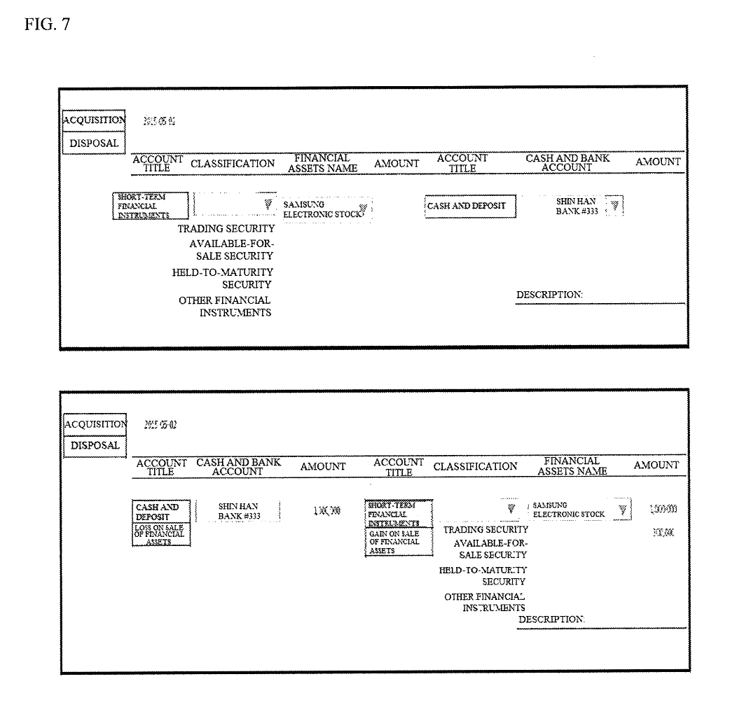

FIG. 7 is a diagram illustrating screens of cases in which acquisition or disposal of short-term financial instruments is selected in the accounting program according to an exemplary embodiment of the present disclosure.

The upper part of FIG. 7 illustrates the transaction information input screen provided when the acquisition of the short-term financial instruments is selected for the accounting period. For the acquisition of the short-term financial instruments, the account attribute table defines the fact that in addition to the account title and the amount, the detailed items and the financial assets name category needs to be generated in the debit side and in addition to the account title and the amount, the cash/bank account category needs to be generated in the credit side. Further, the account attribute table may define the fact that when the acquisition of the short-term financial instruments, and the short-term financial instruments are displayed in the account title of the debit side and the cash and deposits are displayed in the account title of the credit side. When the acquisition of the short-term financial instruments is selected, the detailed item may be provided as a blank and as illustrated in FIG. 6, the possible list of the detailed item may also be proposed.

The lower part of FIG. 7 illustrates the transaction information input screen provided when the disposal of the short-term financial instruments is selected for the accounting period. If the user inputs the amount of the cash and deposits due to the disposal of the short-term financial instruments, the loss amount or the amount of profit may be automatically input to the loss on sale of financial instruments of the credit side or the loss on sale of financial instruments of the debit side depending on the amount of the cash and deposits and the balance of the short-term financial instruments.

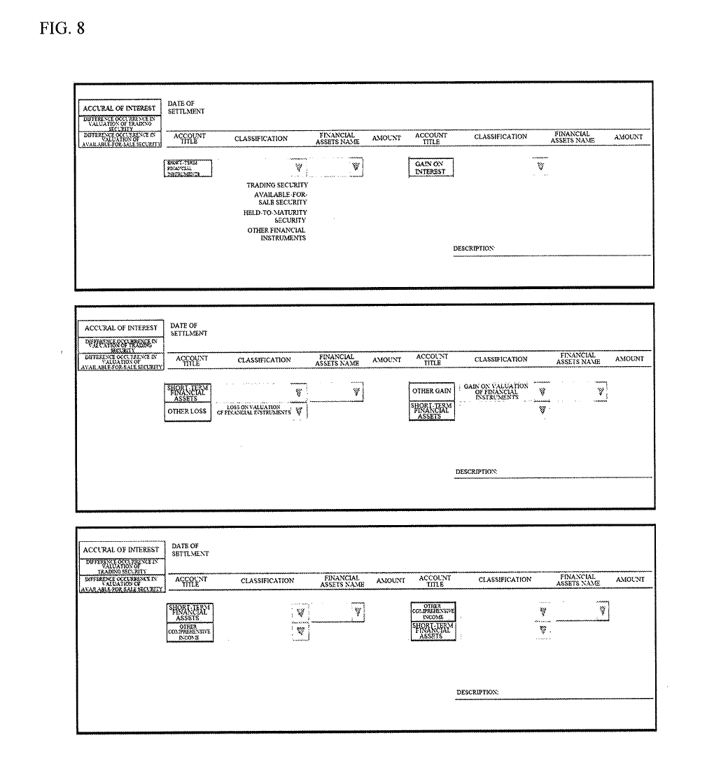

FIG. 8 is a diagram illustrating screens depending on a settlement adjustment type when the settlement of the short-term financial instruments is adjusted in the accounting program according to an exemplary embodiment of the present disclosure. Upon the settlement adjustment of the short-term financial instruments, one of the screens of FIG. 8 may be displayed depending on the required type to guide the input of the user.

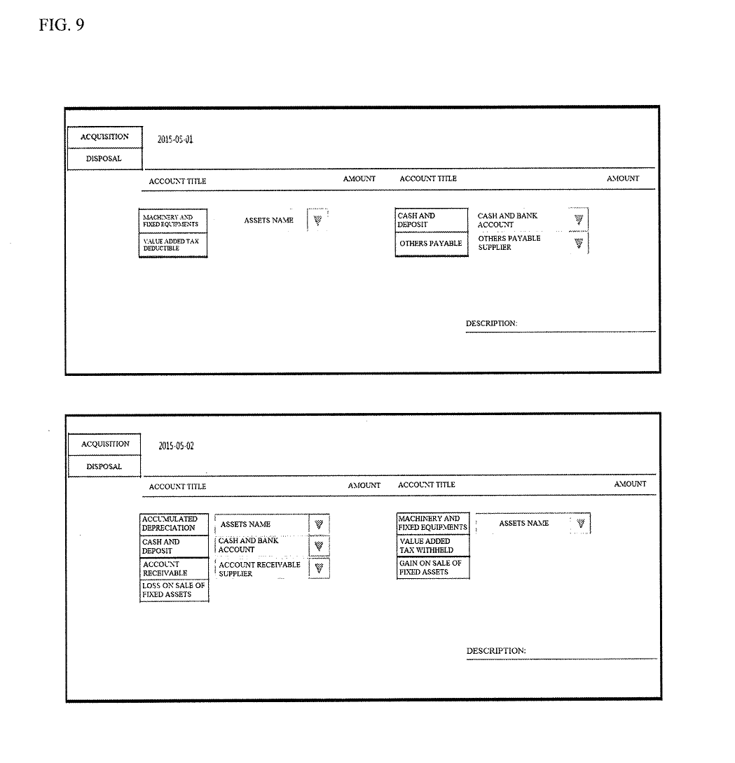

FIG. 9 is a diagram illustrating screens of cases in which acquisition or disposal of machinery and fixed equipment is selected in the accounting program according to an exemplary embodiment of the present disclosure. When the machinery and fixed equipments is acquired, the machinery and fixed equipments and the financial assets name are guided to be input to the debit side and how much the cash and deposits or others payable as cost provided to acquire the machinery and fixed equipments is guided to be input the credit side. When the machinery and fixed equipments are disposed, what the assets name of the disposed machinery and fixed equipments is guided to be input to the credit side and how much the accumulated depreciation of the machinery and fixed equipments is or how much the cash and deposits or the account receivable received through the disposal of the machinery and fixed equipments is guided to be input to the debit side. When the assets name of the disposed machinery and fixed equipments is selected or input, the amount input upon the acquisition of the corresponding machinery and fixed equipments may be automatically input as an amount of the item of the machinery and fixed equipments of the credit side upon the disposal. Further, it is queried how much the accumulated depreciation of the machinery and fixed equipments is by referring the book of the accumulated depreciation of the machinery and fixed equipments depending on the assets name and thus the accumulated depreciation may be automatically input as the amount of the accumulated depreciation of the debit side. If the accumulated depreciation, the cash and deposits, the others payable, the machinery and fixed equipments, and the amount of the value added tax withheld are automatically or manually input, the amount may be automatically input to the gain on sale of fixed assets or the loss on sale of fixed assets depending on the balance between the amounts of the debit side and the credit side.

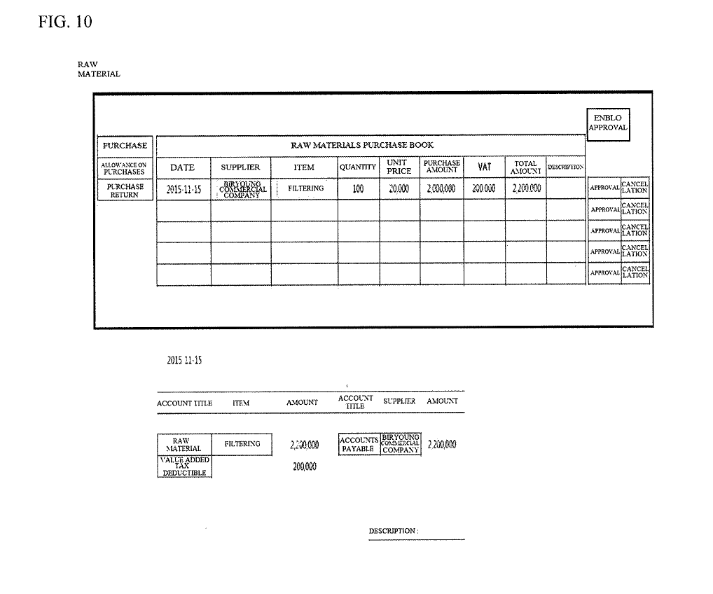

FIG. 10 is a diagram illustrating screens of cases in which a purchase of raw materials is selected in the accounting program according to an exemplary embodiment of the present disclosure.

The account type belongs to the book input, and the raw material is selected in the integrated trial balance and when the raw material purchase is selected, the transaction information input screen is not presented but the book input screen is presented (upper part of FIG. 10). If the detailed items are input/stored in the raw material purchase book, the transaction information input screen like the lower portion of FIG. 10 may be completed depending on the input/stored information and displayed. As the account title that is the book input as the account type so as to be input by the above method, there may be sales, purchase, salary, depreciation, etc.

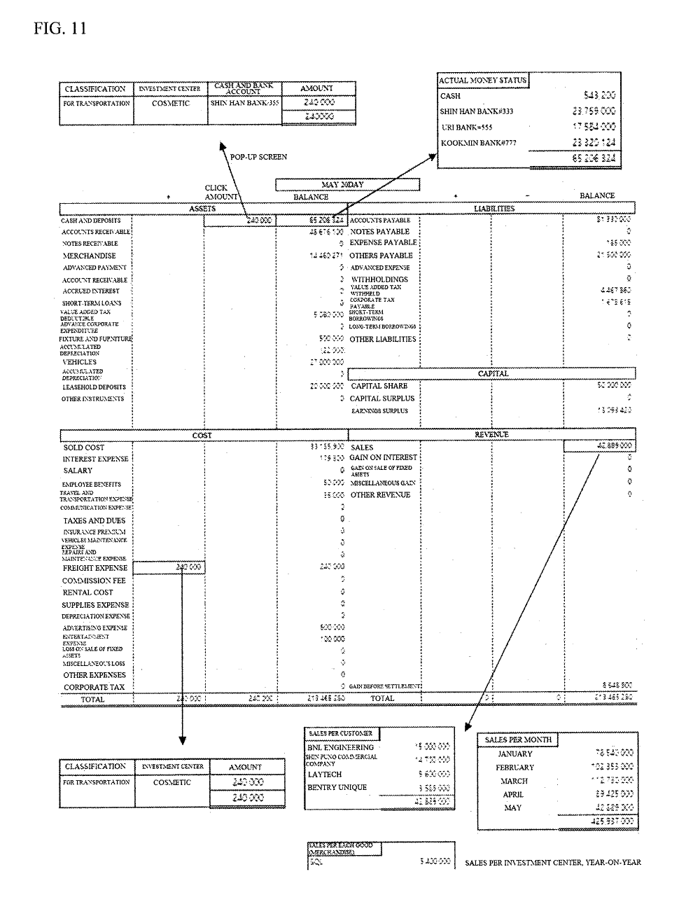

FIG. 11 is a diagram for describing screens of detailed information that may be derived from an integrated trial balance of the accounting program according to an exemplary embodiment of the present disclosure. If the increased amount, the decreased amount, or the balance of each account time in the integrated trial balance illustrated in FIG. 10 is clicked, more detailed information on the corresponding account title may be displayed on a new window or screen. For example, if the decreased amount of the cash and deposits is clicked, the history on how much the cash and deposits are decreased may be shown along with the detailed item, the investment center, the cash/bank account, and the information on the amount in each transaction. If the balance of the cash/deposits is clicked, the actual money status of the cash and deposits may be displayed. That is, it may be displayed in what form (for example, in which account) and how much the cash and deposits remain. If the balance of sales is clicked, sales per customer, sales per month, or sales per merchandise may be displayed. If the balance of sales is clicked, a query occurs to select how much the sales are displayed by the selection of the user or the contents displayed when the balance of the sales is clicked may be determined depending on the preset matters.

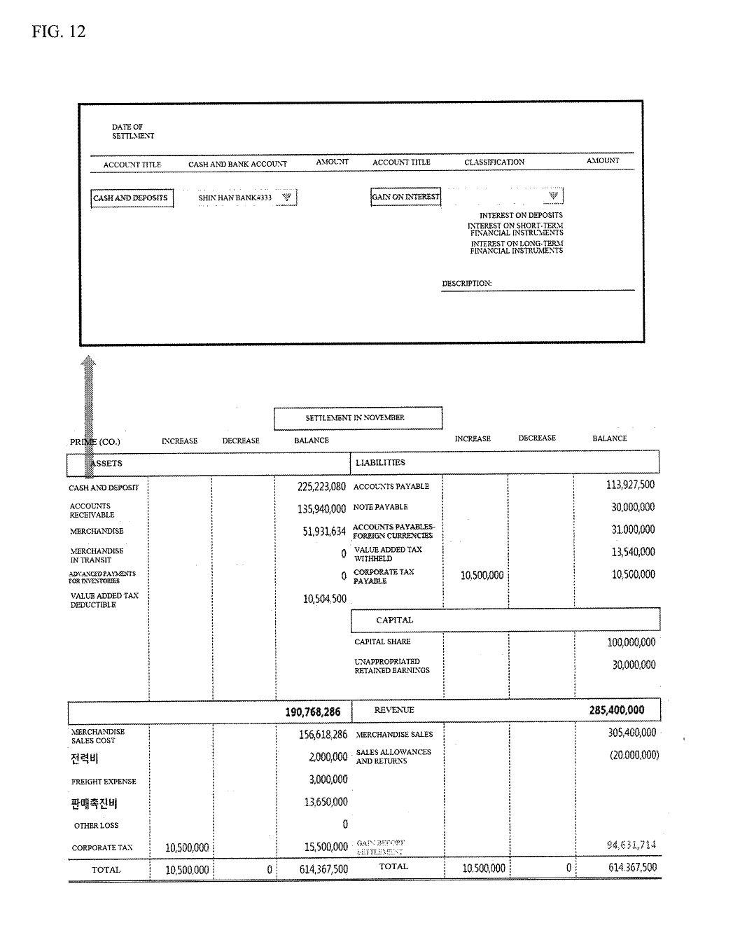

FIG. 12 is a diagram for describing screens that may be displayed upon a settlement mode in the integrated trial balance of the accounting program according to an exemplary embodiment of the present disclosure.

After various transactions are recorded in the integrated trial balance by the recording mode for the accounting period, if the settlement period arrives, the settlement mode may start. The user may click the “settlement” button displayed along with the integrated trial balance to start the settlement mode. Alternatively, the user enters a menu and thus clicks the settlement menu or uses a keyboard shortcut, thereby starting the settlement mode. If the settlement mode is selected, the identification display such as the shade display as illustrated in FIG. 12 may be performed on the account titles requiring the settlement adjustment. If the shaded account title is selected, the items required for the settlement adjustment are displayed and thus the user may input the required information. For example, if the cash and deposits are clicked, the screen displayed at the upper portion of FIG. 12 appears to guide the user to input the amount of the gain on interest.

Further, a function of displaying priority on items to be first processed among the settlement items may be performed based on the settlement adjustment attribute database or the account attribute database. If the account title to be processed prior to the selected account title upon the settlement mode is present, a method for popping-up an information window, etc., may also be used. The accounting program of the present disclosure guides the user to perform all the settlement adjustments in an appropriate order without omission by the settlement mode function.

As described above, the user without sufficient accounting acknowledge may appropriately perform the accounting process and the executives may easily confirm the financial status all the time, by the accounting program based on the integrated trial balance creatively devised and described in the present disclosure.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method for an accounting process using an integrated trial balance executed by a processor, comprising:
presenting the integrated trial balance, the integrated trial balance including a first column and a second column, the first column displaying information on an asset, the second column displaying information on a liability and a capital, the information on the asset, the liability, and the capital including account titles belonging to the asset, the liability, and the capital and values associated with each account title, the integrated trial balance having a recording mode and a settlement mode, if at least some of the account titles on the integrated trial balance are selected in the recording mode, a transaction information input process of the corresponding account title starting, and if at least some of the account titles on the integrated trial balance are selected in the settlement mode, a settlement adjustment process of the corresponding account title starting;
receiving a first select signal selecting one of the account titles displayed in the integrated trial balance in the recording mode;
presenting transaction types for the selected account titles based on a predetermined account attribute table, the account attribute table including possible transaction types according to the account titles and information on automatic recording contents according to a combination of the account titles and the transaction types;
receiving a second select signal selecting one of the presented transaction types; and
presenting a transaction information input screen generated depending on the account attribute table based on the selected account titles and transaction type, the transaction information input screen including a debit side and a credit side and the automatic recording contents determined depending on the account attribute table being automatically input to at least one of the debit side and the credit side and being displayed.

2. The method of claim 1, wherein the account titles and an increased amount, a decreased amount, and a balance for the account titles are displayed in both of the first column and the second column of the integrated trial table.

3. The method of claim 1, wherein the debit side and the credit side of the transaction information input screen each includes an amount input blank for each account title,
the method further comprising:
confirming whether a total of amounts input to all amount input blank of the debit side is equal to a total of amounts input to all amount input blank of the credit side; and
generating an alarm when the total of the amounts input to all amount input blank of the debit side is not equal to the total of the amounts input to all amount input blank of the credit side.

4. The method of claim 1, wherein the debit side and the credit side of the transaction information input screen each include an amount input blank for each account title,
the method further comprising:
confirming whether a total of the amounts input to all amount input blank of the debit side is equal to a total of the amounts input to all amount input blank of the credit side; and
when a total of amounts of the debit side is equal to a total of amounts of the credit side, updating amount input of each account title to the value of the corresponding account title in the integrated trial balance.

5. The method of claim 1, further comprising:
prior to the presenting of the integrated trial balance,
receiving a business select signal for a business field; and
configuring the integrated trial balance with account titles to be used in the selected business field depending on a predetermined business attribute table, based on the business select signal.

6. The method of claim 1, further comprising:
after the presenting of the transaction information input screen,
receiving a settlement mode signal;
generating an identification mark for the account titles requiring the settlement adjustment among the account titles in the integrated trial balance; and
displaying matters to be input by a user for the corresponding account title depending on a predetermined settlement adjustment table if one of the account titles for which the identification mark is generated is selected.

7. A computer-readable recording medium comprising computer executable instructions, which, when executed by a processor, cause the processor to perform the steps of claim 1.

8. An apparatus for an accounting process using an integrated trial balance, comprising:
a memory storing an account attribute table including possible transaction types according to account titles and information on automatic recording contents according to a combination of the accounts and the transaction types; and
a processor connected to the memory,
wherein the processor performs an operation of presenting the integrated trial balance to a user device, the integrated trial balance including a first column and a second column, the first column displaying information on an asset, the second column displaying information on a liability and a capital, the information on the asset, the liability, and the capital including account titles belonging to the asset, the liability, and the capital and values associated with each account title, the integrated trial balance having a recording mode and a settlement mode, if at least some of the account titles on the integrated trial balance are selected in the recording mode, a transaction information input process of the corresponding account title starting, and if at least some of the account titles on the integrated trial balance are selected in the settlement mode, a settlement adjustment process of the corresponding account title starting, and the processor performs an operation of receiving a select signal selecting one of the account titles and one of the transaction types of the corresponding account title displayed in the integrated trial table in the recording mode and presenting a transaction information input screen generated according to the account attribute table based on the selected account titles and transaction types, the transaction information input screen including a debit side and a credit side and the automatic recording contents determined depending on the account attribute table being automatically input to at least one of the debit side and the credit side and being displayed.

9. The apparatus of claim 8, wherein the account titles and an increased amount, a decreased amount, and a balance for the account titles are displayed in both of the first column and the second column of the integrated trial table.

10. The apparatus of claim 8, wherein the debit side and the credit side of the transaction information input screen each include an amount input blank for each account title, and
the operation further includes:
confirming whether a total of the amounts input to all amount input blank of the debit side is equal to a total of the amounts input to all amount input blank of the credit side; and
generating an alarm when the total of the amounts input to all amount input blank of the debit side is not equal to the total of the amounts input to all amount input blank of the credit side.

11. The apparatus of claim 8, wherein the debit side and the credit side of the transaction information input screen each include an amount input blank for each account title, and
the operation further includes:
confirming whether a total of the amounts input to all amount input blank of the debit side is equal to a total of the amounts input to all amount input blank of the credit side; and
when a total of amounts of the debit side is equal to a total of amounts of the credit side, updating amount input of each account title to the value of the corresponding account title in the integrated trial balance.

12. The apparatus of claim 8, wherein the operation further includes:
prior to the presenting of the integrated trial balance,
receiving a business select signal for a business field; and
configuring the integrated trial balance using account titles to be used in the business field selected depending on a predetermined business attribute table, based on the business select signal.

13. The apparatus of claim 8, wherein the operation further includes:
after the presenting of the transaction information input screen,
receiving a settlement mode signal;
generating an identification mark for the account titles requiring the settlement adjustment among the account titles in the integrated trial balance; and
displaying matters to be input by a user for the corresponding account title depending on a predetermined settlement adjustment table if one of the account titles for which the identification mark is generated is selected.

14. An apparatus for an accounting process using an integrated trial balance, comprising:
an account title database per business field defining account titles to be displayed in the integrated trial balance per business field;
an account attribute database defining attributes of each account, the account attribute database storing display information when the account titles are selected in a recording mode or a settlement mode;
an integrated trial balance configuration module configuring the integrated trial balance including the account titles based on the account title database per business field according to the business field selected by a user, the integrated trial balance including a first column and a second column, the first column displaying information on an asset, the second column displaying information on a liability and a capital, the information on the asset, the liability, and the capital including account titles belonging to the asset, the liability, and the capital and values associated with each account title, the integrated trial balance having a recording mode and a settlement mode, if at least some of the account titles on the integrated trial balance are selected in the recording mode, a transaction information input process of the corresponding account title starting, and if at least some of the account titles on the integrated trial balance are selected in the settlement mode, a settlement adjustment process of the corresponding account title starting;
a transaction information input module presenting transaction types for the selected account titles based on the account attribute database when a first select signal selecting one of the account titles displayed in the integrated trial balance is received in the recording mode and presenting a transaction information input screen generated depending on the account attribute database based on the selected account title and transaction type; and
a settlement management module generating an identification mark for the account titles requiring the settlement adjustment among the account titles of the integrated trial balance in the settlement mode and displaying matters to be input by the user for the corresponding account title based on the account attribute database if one of the account titles for which the identification mark is generated is selected.

15. The method of claim 2, wherein the debit side and the credit side of the transaction information input screen each includes an amount input blank for each account title,
the method further comprising:
confirming whether a total of amounts input to all amount input blank of the debit side is equal to a total of amounts input to all amount input blank of the credit side; and
generating an alarm when the total of the amounts input to all amount input blank of the debit side is not equal to the total of the amounts input to all amount input blank of the credit side.

16. The method of claim 2, wherein the debit side and the credit side of the transaction information input screen each include an amount input blank for each account title,
the method further comprising:
confirming whether a total of the amounts input to all amount input blank of the debit side is equal to a total of the amounts input to all amount input blank of the credit side; and
when a total of amounts of the debit side is equal to a total of amounts of the credit side, updating amount input of each account title to the value of the corresponding account title in the integrated trial balance.

17. The method of claim 2, further comprising:
prior to the presenting of the integrated trial balance,
receiving a business select signal for a business field; and
configuring the integrated trial balance with account titles to be used in the selected business field depending on a predetermined business attribute table, based on the business select signal.

18. The method of claim 2, further comprising:
after the presenting of the transaction information input screen,
receiving a settlement mode signal;
generating an identification mark for the account titles requiring the settlement adjustment among the account titles in the integrated trial balance; and
displaying matters to be input by a user for the corresponding account title depending on a predetermined settlement adjustment table if one of the account titles for which the identification mark is generated is selected.

19. A computer-readable recording medium comprising computer executable instructions, which, when executed by a processor, cause the processor to perform the steps of claim 2.

20. The apparatus of claim 9, wherein the debit side and the credit side of the transaction information input screen each include an amount input blank for each account title, and
the operation further includes:
confirming whether a total of the amounts input to all amount input blank of the debit side is equal to a total of the amounts input to all amount input blank of the credit side; and
generating an alarm when the total of the amounts input to all amount input blank of the debit side is not equal to the total of the amounts input to all amount input blank of the credit side.

21. The apparatus of claim 9, wherein the debit side and the credit side of the transaction information input screen each include an amount input blank for each account title, and
the operation further includes:
confirming whether a total of the amounts input to all amount input blank of the debit side is equal to a total of the amounts input to all amount input blank of the credit side; and
when a total of amounts of the debit side is equal to a total of amounts of the credit side, updating amount input of each account title to the value of the corresponding account title in the integrated trial balance.

22. The apparatus of claim 9, wherein the operation further includes:
prior to the presenting of the integrated trial balance,
receiving a business select signal for a business field; and
configuring the integrated trial balance using account titles to be used in the business field selected depending on a predetermined business attribute table, based on the business select signal.

23. The apparatus of claim 9, wherein the operation further includes:
after the presenting of the transaction information input screen,
receiving a settlement mode signal;
generating an identification mark for the account titles requiring the settlement adjustment among the account titles in the integrated trial balance; and
displaying matters to be input by a user for the corresponding account title depending on a predetermined settlement adjustment table if one of the account titles for which the identification mark is generated is selected.
